(19) United States
(12) Patent Application Publication
(10) Pub. No.: US 2011/0241803 A1
(43) Pub. Date: Oct. 6, 2011

(54) SIGNAL TRANSMISSION LINE

(75) Inventor: Koji Tsukashima, Kanagawa (JP)

(73) Assignee: SUMITOMO ELECTRIC INDUSTRIES, LTD., Osaka (JP)

(21) Appl. No.: 13/076,887

(22) Filed: Mar. 31, 2011

(30) Foreign Application Priority Data
Apr. 1, 2010 (JP) 2010-085416

(51) Int. Cl. H01P 3/08

(52) U.S. Cl. 333/238

(57) ABSTRACT

A signal transmission line includes a dielectric substrate having first and second surfaces opposite to each other, a first conductor layer provided between the first surface and the second surface and set at a ground potential, a first transmission line having a signal conductor that is provided on the first surface and has a capacitive coupling with the first conductor layer, a second transmission line provided on the second surface, and a connecting conductor that passes through the dielectric substrate and connects the signal conductor of the first transmission line and the second transmission line. The first conductor layer has a first opening in which the connecting conductor is located. A distance between the first conductor layer and the connecting conductor in a first direction in which the signal conductor extends is smaller than a distance between the first conductor layer and the connecting conductor in a second direction orthogonal to the first direction.

### CROSS-REFERENCE TO RELATED APPLICATION

This application is based upon and claims the benefit of priority of the prior Japanese Patent Application No. 2010-085416, filed on Apr. 1, 2010, the entire contents of which are incorporated herein by reference.

### BACKGROUND

(i) Technical Field

A certain aspect of the embodiments discussed herein is related to a signal transmission line.

(ii) Related Art

There is known a signal transmission line that transmits an RF or high-frequency signal in which a via interconnection is formed in a substrate and upper and lower signal lines are connected by the via interconnection. For example, Japanese Patent Application Publication No. 2003-282780 discloses a semiconductor device in which upper and lower signal lines in a substrate are connected by a via interconnection formed in an insulation layer.

In order to improve the performance of devices that handle RF signals, it is required to reduce loss of signals in signal transmission lines.

### SUMMARY

According to an aspect of the present invention, there is provided a signal transmission line having a reduced loss of signal.

According to another aspect of the present invention, there is provided a signal transmission line including: a dielectric substrate having a first surface and a second surface opposite to the first surface; a first conductor layer provided between the first surface and the second surface and set at a ground potential; a first transmission line having a signal conductor that is provided on the first surface and has a capacitive coupling with the first conductor layer; a second transmission line provided on the second surface; and a connecting conductor that passes through the dielectric substrate and connects the signal conductor of the first transmission line and the second transmission line, the first conductor layer having a first opening in which the connecting conductor is located, a distance between the first conductor layer and the connecting conductor in a first direction in which the signal conductor of the first transmission line extends being smaller than a distance between the first conductor layer and the connecting conductor in a second direction orthogonal to the first direction.

### BRIEF DESCRIPTION OF THE DRAWINGS

FIG. 1A is a cross-sectional view of a signal transmission line in accordance with a comparative example, and FIG. 1B is a plan view of the signal transmission line;

FIG. 2A is a perspective view of sample A, and FIGS. 2B through 2E are plan views of first through fourth layers of the sample A, respectively;

FIG. 3A is a perspective view of sample B, and FIG. 3B is a plan view of a second layer of the sample B;

FIG. 4A is a graph of results of computation of transmission loss; and FIG. 4B is a graph of results of computation of reflection characteristics;

FIG. 5A is a cross-sectional view of a signal transmission line in accordance with a first embodiment, FIG. 5B is a plan view of a signal transmission line, and FIG. 5C is a plan view of a first signal conductor;

FIG. 6A is a cross-sectional view of a signal transmission line in accordance with a second embodiment, FIG. 6B is a plan view of a first signal conductor and a ground layer; FIG. 6C is a plan view of a conductor layer, and FIG. 6D is a plan view of a second signal conductor and a ground layer;

FIG. 7A is a cross-sectional view of a signal transmission line in accordance with a third embodiment, and FIG. 7B is a plan view of a conductor layer;

FIG. 8A is a cross-sectional view of a signal transmission line in accordance with a fourth embodiment, FIG. 8B is a plan view of conductor layers, and FIG. 8C is a plan view of yet another conductor layer;

FIG. 9A is a cross-sectional view of a signal transmission line in accordance with a fifth embodiment, and FIG. 9B is a plan view of a conductor layer; and

FIG. 10A is a cross-sectional view of a signal transmission line in accordance with a sixth embodiment, and FIG. 10B is a plan view of a signal transmission line.

### DETAILED DESCRIPTION

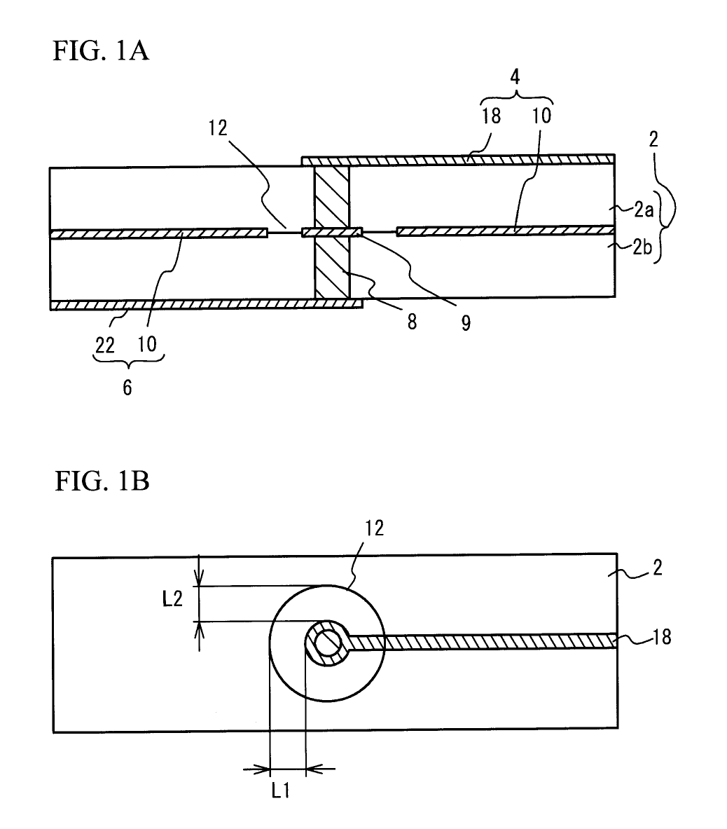

First, a comparative example is described. A comparative example has an exemplary structure in which microstrip lines formed on upper and lower surfaces of a dielectric substrate are connected by a via interconnection (connecting conductor). FIG. 1A is a cross-sectional view of a signal transmission line of the comparative example, and FIG. 1B is a plan view of the signal transmission line. FIG. 1B is a top view of the signal transmission line seen through a dielectric layer 2a.

Referring to FIG. 1A, the signal transmission line of the comparative example has a dielectric substrate 2, a first transmission line 4, a second transmission line 6, a via interconnection 8, and a conductor layer 10. The dielectric substrate 2 is a multilayer wiring substrate, and may be made of a dielectric substance such as glass epoxy resin or fluorocarbon resin dielectric substance. In the present example, the dielectric substrate 1 has a two-layer structure composed of a dielectric layer 2a and a dielectric layer 2b.

A first signal conductor 18 of the first transmission line 4 is formed on the upper surface of the dielectric substrate 2. A second signal conductor 22 of the second signal transmission line 6 is formed on the lower surface of the dielectric substrate 2 opposite to the upper surface. The first signal conductor 18 and the second signal conductor 22 are connected by the via interconnection 8 that passes through the dielectric layers 2a and 2b. The conductor layer 10 is interposed between the dielectric layers 2a and 2b. A land pattern 9 having a diameter larger than the via interconnection 8 is formed between the dielectric layers 2a and 2b in an area in which the via interconnection 8 is provided.

As illustrated in FIGS. 1A and 1B, the conductor layer 10 is arranged so as to have a portion opposite to the first signal conductor 18 and another portion opposite to the second signal conductor 22. The conductor layer 10 is set at the ground potential. The first signal conductor 18 and the conductor layer 10 form a microstrip line. Similarly, the second signal conductor 22 and the conductor layer 10 form another microstrip line.

An opening 12 is formed in the conductor layer 10 and a land pattern 9 is formed in the opening 12. A distance L1 between the conductor layer 10 and the land pattern 9 in the direction in which the first signal conductor 18 extends is equal to a distance L2 between the conductor layer 10 and the land pattern 9 in a direction orthogonal to the direction in which the first signal conductor 18 extends. In FIG. 1B, the land pattern 9 is illustrated so as to overlap an end of the first signal conductor 18. That is, the distance between the conductor layer 10 and the via interconnection 8 in the direction in which the first signal conductor 18 extends is equal to the distance between the conductor layer 10 and the via interconnection 8 in the direction orthogonal to the direction in which the first signal conductor 18 extends. In other words, the opening 12 has a circular shape.

The microstrip line formed by the first signal conductor 18 and the conductor layer 10, and the microstrip line formed by the second signal conductor 22 and the conductor layer 10 have a characteristic impedance of, for example, 50Ω.

It is to be noted that the conductor layer 10 does not exist below the first signal conductor 18 in the vicinity of the connection of the first signal conductor 18 and the via interconnection 8. An area in which the conductor layer 10 does not exist below the first signal conductor 18 has a characteristic impedance different from that of an area in which the first signal conductor 18 is opposite to the conductor layer 10. In case where the area in which the conductor layer 10 does not exist below the first signal conductor 18 is large, there is a large impedance discontinuity in the connection of the first signal conductor 18 and the via interconnection 8. The impedance discontinuity results in reflection and dispersion of signal and increases loss of signal. Particularly, the loss of signal is conspicuous in RF signals in the millimeter wave band or in a higher band.

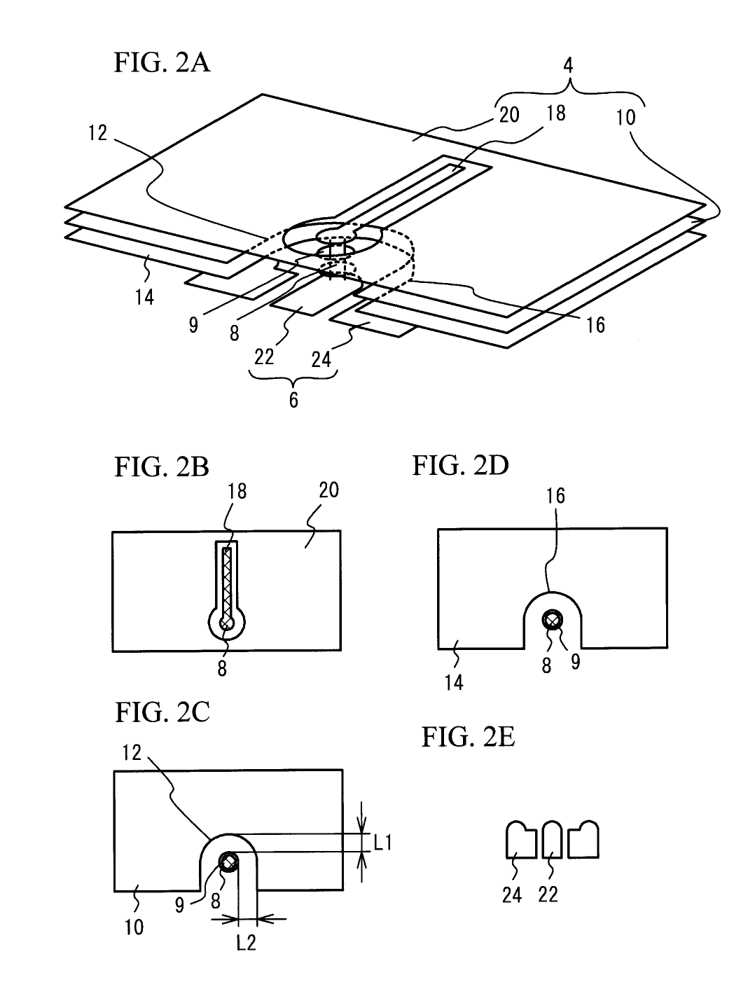

A description is now given of an experiment conducted by the inventors in order to reduce the loss of signal. Sample used in the experiment are as follows. FIG. 2A is a perspective view of sample A used in the experiment, and FIGS. 2B, 2C, 2D and 2E are respectively plan views of the first signal conductor 18, the ground layer 20, the conductor layer 10, the conductor layer 14, and the second signal conductor 22 of the sample A. These parts are seen through the dielectric substrate 2.

As illustrated in FIG. 2A, the sample A is a signal transmission line formed by stacking layers of the first signal conductor 18 and the ground layer 20, the layer of the conductor layer 10, the layer of the conductor layer 14, and the layers of the second signal conductor 22 and the ground layer 24 in this order from the top side. The first signal conductor 18 is provided on the upper surface of the dielectric substrate, and the second signal conductor 22 is provided on the lower surface thereof. The opening 12 is formed in the conductor layer 10, and an opening 16 is formed in the conductor layer 14. The via interconnection 8 that connects the first signal conductor 18 and the second signal conductor 22 is arranged in the openings 12 and 16 via the land pattern 9 for the via interconnection 8. Each layer of the sample A is described below in detail.

As illustrated in FIGS. 2A and 2B, the first transmission line 4 is equipped with the first signal conductor 18 and the ground layer 20. The conductor layer 10 functions as a ground layer of the first signal conductor 18. That is, the first transmission line 4 is a grounded coplanar line.

As illustrated in FIGS. 2A and 2C, the conductor layer 10 has the opening 12 that is open in the direction opposite to the direction in which the first signal conductor 18 runs. The opening 12 is formed so that the distance L1 between the conductor layer 10 and the land pattern 9 in the direction in which the first signal conductor extends is equal to the distance L2 between the conductor layer 10 and the land pattern 9 in the direction orthogonal to the direction in which the first signal conductor 18 extends.

As illustrated in FIGS. 2A and 2D, the conductor layer 14 has the opening 16 that is open in the direction opposite to the direction in which the first signal conductor 18 extends. Like the opening 12, the opening 16 is formed so that the distance between the conductor layer 14 and the land pattern 9 in the direction in which the first signal conductor 18 extends is equal to the distance between the conductor layer 14 and the land pattern 9 in the direction orthogonal to the direction in which the first signal conductor 18 extends.

As illustrated in FIGS. 2A and 2E, the second transmission line 6 is equipped with the second signal conductor 22 that extends in the direction opposite to the direction in which the first signal conductor 18 extends, and the ground layer 24. That is, the second transmission line 6 is a coplanar line.

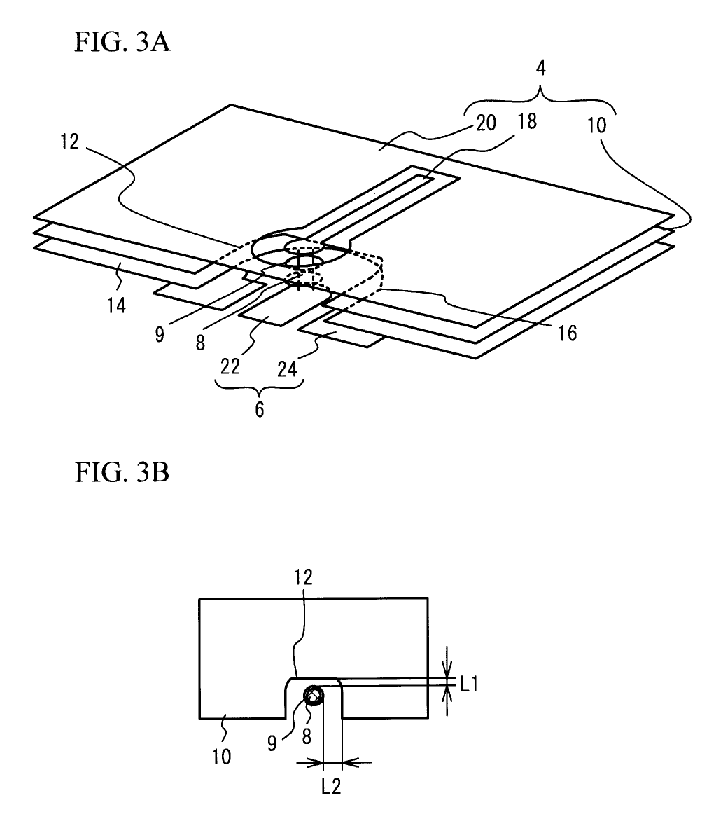

Now, a sample B is described. FIG. 3A is a perspective view of a sample B, and FIG. 3B is a plan view of the conductor layer 10 employed in the sample B.

As illustrated in FIG. 3A, like the sample A, the sample B is a signal transmission line formed by stacking layers of the first signal conductor 18 and the ground layer 20, the layer of the conductor layer 10, the layer of the conductor layer 14, and the layers of the second signal conductor 22 and the ground layer 24 in this order from the top side. The shape of the opening 12 formed in the conductor layer 10 of the sample B is different from that of the sample A.

As illustrated in FIG. 3B, the conductor layer 10 of the sample B has the opening 12 that is open in the direction opposite to the direction in which the first signal conductor 18 extends. The opening 12 is formed so that the distance L1 between the conductor layer 10 and the land pattern 9 in the direction in which the first signal conductor 18 extends is smaller than the distance L2 between the conductor layer 10 and the land pattern 9 in the direction orthogonal to the direction in which the first signal conductor 18 extends. That is, the distance between the conductor layer 10 and the via interconnection 8 in the direction in which the first signal conductor 18 extends is smaller than the distance between the conductor layer 10 and the via interconnection 8 in the direction orthogonal to the direction in which the first signal conductor 18 extends.

The dielectric substrate 2 is 0.075 mm thick. In the sample A, the distances L1 and L2 are 0.2875 mm. In the sample B, the distance L1 is 0.05 mm, and the distance L2 is 0.2875 mm. The dielectric substrate 2 is made of alumina ceramic and has a dielectric constant of 7.6. The first signal conductor 18, the second signal conductor 22, the conductor layer 10 and the conductor layer 14 are made of Cu.

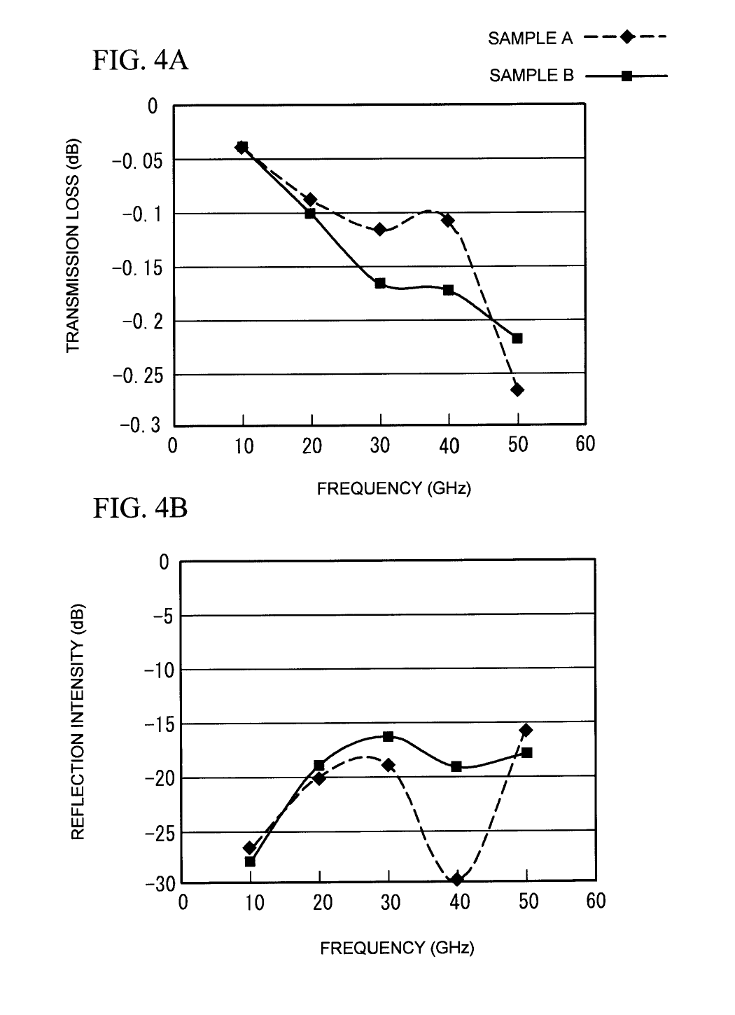

Now, the results of the experiment are described. FIG. 4A is a graph of results of computing the transmission losses of the samples A and B, and FIG. 4B is a graph of results of computing the reflection characteristics thereof. The vertical axis of FIG. 4A denotes the transmission loss, and the vertical axis of FIG. 4B denotes the reflection intensity. The horizontal axes of FIGS. 4A and 4B denote frequency. In FIGS. 4A and 4B, curves described by broken lines and rhombic symbols describe the results of the sample A, and those described by solid lines and square symbols describe the results of the sample B.

As illustrated in FIG. 4A, in a band as high as 50 GHz, the transmission loss of the sample A increases rapidly, while the transmission loss of the sample B does not have an increase as much as that of the sample A. As illustrated in FIG. 4B, in a wide frequency band of 10 to 50 GHz, the sample B does not have variation in the reflection characteristic as great as that of the sample A. That is, the sample B having the modified shape of the opening 12 formed in the conductor layer 10 has a smaller change in the frequency-dependent characteristics than the sample A, and is particularly much better at high frequencies.

The results of the experiment are studied. As described above, the sample A has an impedance discontinuity in the connection of the first signal conductor 18 and the via interconnection 8. Thus, there is a difficulty in realizing a desired impedance, and the characteristics are degraded considerably at high frequencies.

In contrast, the sample B is configured so that the distance L1 between the conductor layer 10 and the land pattern 9 in the direction in which the first signal conductor 18 extends is smaller than the distance L2 between the conductor layer 10 and the land pattern 9 in the direction orthogonal to the direction in which the first signal conductor 18 extends. Thus, the conductor layer 10 of the sample B in the direction in which the first signal conductor 18 extends up to a position closer to the via interconnection 8 than the position in the sample A. Thus, the area in which the first signal conductor 18 and the conductor layer 10 are opposite to each other in the sample B extends to a position closer to the via interconnection 8 than the position in the sample A. Thus, the sample B has a smaller impedance discontinuity in the connection of the first signal conductor 18 and the via interconnection 8 than the sample A. Therefore, the sample B has improved characteristics as illustrated FIGS. 4A and 4B.

For example, if it is attempted to reduce the discontinuity of the ground layer while keeping the circular shape of the opening 12, the diameter of the opening 12 will be reduced. As the diameter of the opening 12 decreases, the impedance of the via interconnection 8 decreases. It can be seen from the above that the sample B has a preferable structure in which the conductor layer 10 of the ground layer is extended as close to the through hole in the dielectric substrate 2 having the via interconnection 8 as possible in order to reduce the impedance discontinuity, and the size of the opening is enlarged in the direction orthogonal to the direction in which the signal conductor extends in order to restrain decrease in the impedance. The opening 12 of the sample B having the elliptical shape may be changed to a rectangular shape. However, the rectangular shape of the opening 12 may bring about large sparse and dense distributions in the magnetic and electric fields. It is therefore preferable to employ the opening 12 having a curvature, that is, an elliptical shape.

Embodiments of the present invention are now described with reference to the accompanying drawings.

### First Embodiment

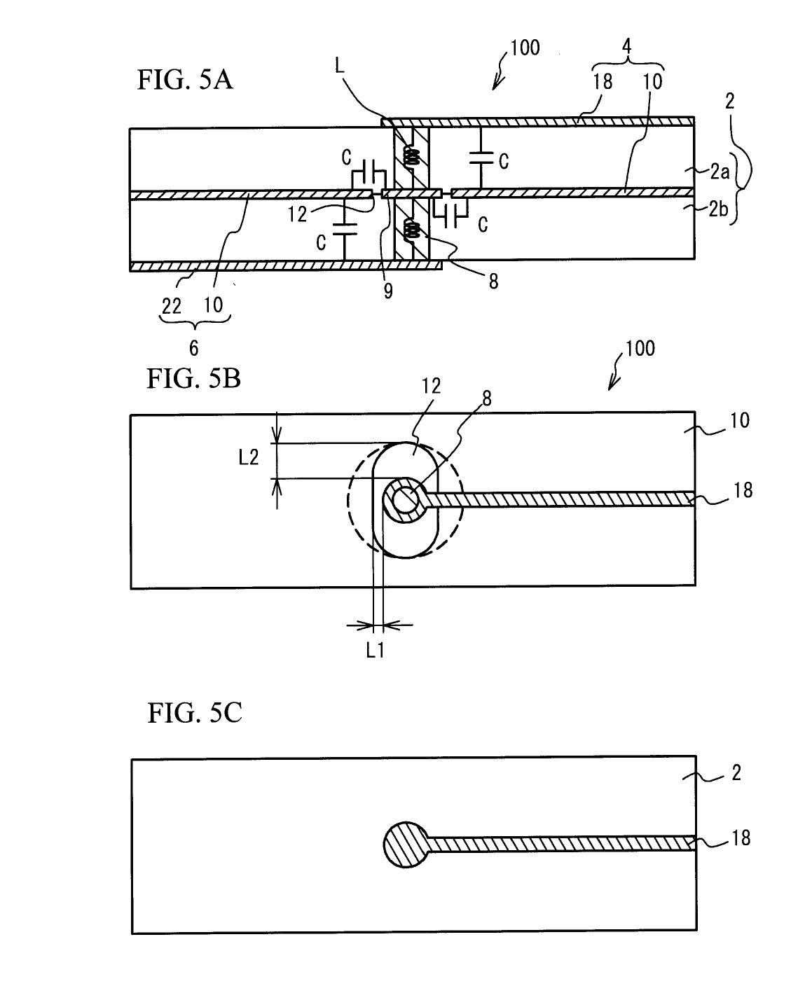

A first embodiment is an example using a microstrip line. FIG. 5A is a cross-sectional view of a signal transmission line 100 of the first embodiment, FIG. 5B is a plan view of the signal transmission line 100, and FIG. 5C is a plan view of the first signal conductor 18 employed in the first embodiment. In FIG. 5B, some components are seen through the dielectric layer 2a.

As illustrated in FIGS. 5A and 5B, the signal transmission line 100 of the first embodiment is composed of the dielectric substrate 2, the first transmission line 4, the second transmission line 6, the via interconnection 8 (connecting conductor), the land pattern 9, and the conductor layer 10 (first conductor layer). The dielectric substrate 2 is a multilayer substrate, and the first signal conductor 18 and the conductor layer 10 are provided so as to overlap each other. The second signal conductor 22 and the conductor layer 10 are provided so as to overlap each other. The conductor layer 10 extend in the direction in which the first signal conductor 18 extends and in the direction in which the second signal conductor 22 extends.

As illustrated in FIGS. 5A and 5C, the first signal conductor 18 is provided on the upper surface (first surface) of the dielectric substrate 2. The second signal conductor 22 is provided on the lower surface (second surface) of the dielectric substrate 2. The via interconnection 8 passes through the dielectric substrate 2 from the upper surface to the lower surface via the land pattern interposed between the upper and lower surfaces of the dielectric substrate 2. The first signal conductor 18 and the second signal conductor 22 are connected by the via interconnection 8. The conductor layer 10 is provided in the dielectric substrate 2 and is interposed between the upper and lower surfaces of the dielectric substrate 2.

The first signal conductor 18 and the conductor layer 10 form the first transmission line 4 of a microstrip line. The first signal conductor 18 functions as a signal line, and the conductor layer 10 functions as a ground layer. The second signal conductor 22 and the conductor layer 10 form the second transmission line 6 of a microstrip line. The second signal conductor 22 functions as a signal line, and the conductor layer 10 functions as a ground layer. The characteristic impedances of the first transmission line 4 and the second transmission line 6 may be set equal to, for example, 50Ω. The opening 12 (first opening) is formed in the conductor layer 10, and the land pattern 9 is located in the opening 12.

As schematically illustrated in FIG. 5A, the via interconnection 8 has inductance components indicated by “L”. The first signal conductor 18 and the conductor layer 10 form a capacitive coupling, the second signal conductor 22 and the conductor layer 10 form another capacitive coupling, and the land pattern 9 and the conductor layer 10 form a further capacitive coupling. These couplings are indicated by “C”.

As illustrated in FIG. 5B, the opening 12 employed in the first embodiment is configured so that the distance L1 between the conductor layer 10 and the land pattern 9 in the direction in which the first signal conductor 18 extends is smaller than the opening 12 of the comparative example illustrated by a broken line. That is, the opening 12 of the first embodiment is configured so that the distance L1 is smaller than the distance L2 between the conductor layer 10 and the land pattern 9 in the direction orthogonal to the direction in which the first signal conductor 18 extends. The distance L1 is smaller than the distance between the conductor layer 10 and the land pattern 9 in the direction in which the first signal conductor 18 extends. That is, the distance between the conductor layer 10 and the via interconnection 8 in the direction in which the first signal conductor 18 extends is smaller than the distance between the conductor layer 10 and the via interconnection 8 in the direction orthogonal to the direction in which the first signal conductor 18 extends. The conductor layer 10 surrounds the opening 12. The distance between the via interconnection 8 and the conductor layer 10 is set to a value close to the characteristic impedances (for example, 50Ω) of the first and second transmission lines 4 and 6.

According to the first embodiment, since the distance L1 is set smaller than that of the comparative example, the characteristic impedance of the first transmission line 4 may be maintained at a desired value (for example, 50Ω) up to the proximity of the via interconnection 8.

That is, the connection of the first and second transmission lines 4 and 6 and the via interconnection 8 has a reduced impedance discontinuity. It is easy to make the impedance of the via interconnection 8 close to the impedance of the first transmission line 4 and that of the second transmission line 6. Thus, it is possible to reduce the loss of signal on the signal transmission line. As has been described in connection with our experiment, great improvements in the loss of signal can be realized particularly in RF signals as high as 50 GHz or higher.

### Second Embodiment

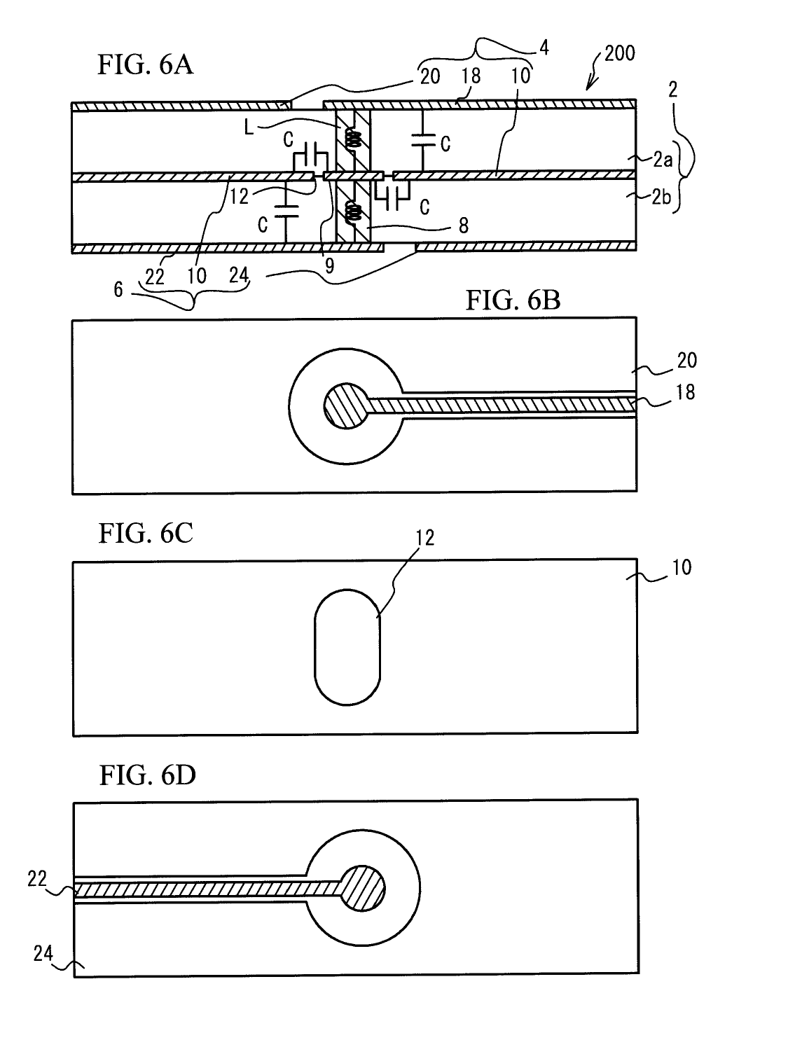

A second embodiment is an example using a grounded coplanar line. FIG. 6A is a cross-sectional view of a signal transmission line 200 in accordance with the second embodiment, FIG. 6B is a plan view of the first signal conductor 18 and the ground layer 20 employed in the second embodiment, FIG. 6C is a plan view of the conductor layer 10 employed in the second embodiment, and FIG. 6D is a plan view of the second signal conductor 22 and the ground layer 24 employed in the second embodiment.

As illustrated in FIGS. 6A and 6B, the first signal conductor 18 and the ground layer 20 are formed on the upper surface of the dielectric substrate 2. The conductor layer 10 functions as a ground layer opposite to the first signal conductor 18. That is, the first transmission line 4 is a grounded coplanar line.

As illustrated in FIGS. 6A and 6D, the second signal conductor 22 and the ground layer 24 are formed on the lower surface of the dielectric substrate 2. The conductor layer 10 functions as a ground layer opposite to the second signal conductor 22. That is, the second signal transmission line 6 also functions as a grounded coplanar line like the first signal transmission conductor 4.

As illustrated in FIGS. 6A and 6C, the conductor layer 10 of the second embodiment has the same configuration as that of the first embodiment. That is, the opening 12 is formed in the conductor layer 10 so that the distance between the conductor layer 10 and the land pattern 9 in the direction in which the first signal conductor 18 extends is smaller than the distance between the conductor layer 10 and the land pattern 9 in the direction orthogonal to the direction in which the first signal conductor 18 extends.

According to the second embodiment, the connection of the first and second transmission lines 4 and 6 and the via interconnection 8 has a reduced impedance discontinuity. It is easy to make the impedance of the via interconnection 8 close to the impedance of the first transmission line 4 and that of the second transmission line 6. Thus, it is possible to reduce the loss of signal on the signal transmission line.

### Third Embodiment

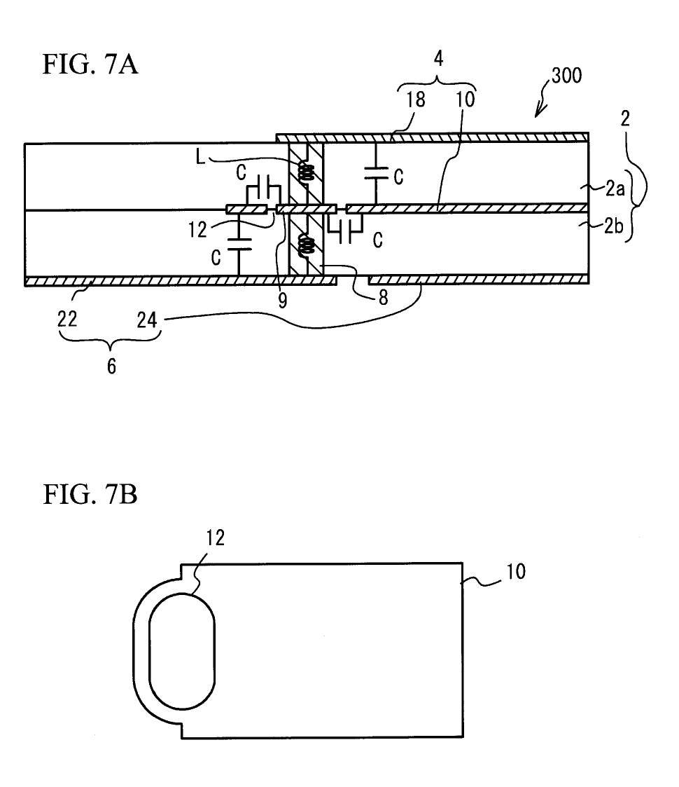

A third embodiment is an example using a microstrip line and a coplanar line. FIG. 7A is a cross-sectional view of a signal transmission line 300 in accordance with a third embodiment, and FIG. 7B is a plan view of the conductor layer 10 employed in the third embodiment.

As illustrated in FIGS. 7A and 7B, the conductor layer 10 extends in the direction in which the first signal conductor 18 extends, and the opening 12 is formed in the conductor layer 10. The conductor layer 10 surrounds the opening 12. The first transmission line 4 employed in the third embodiment is a microstrip line like the first transmission line of the first embodiment, and the second transmission line 6 is a coplanar line.

According to the third embodiment, it is possible to reduce the impedance discontinuity in the connection of the first transmission line 4 and the via interconnection 8 and that in the connection of the second transmission line 6 and the via interconnection 8. It is easy to make the impedance of the via interconnection 8 close to the impedance of the first transmission line 4 and that of the second transmission line 6. Thus, it is possible to reduce the loss of signal on the signal transmission line.

### Fourth Embodiment

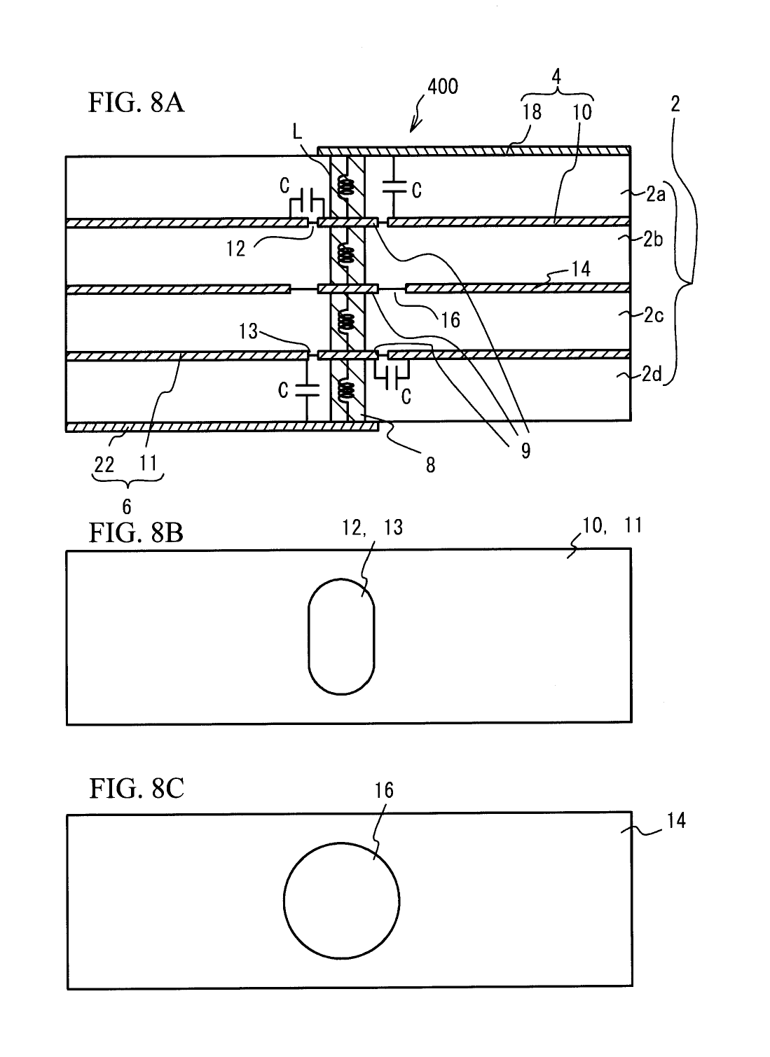

A fourth embodiment is an example having multiple conductor layers. FIG. 8A is a cross-sectional view of a signal transmission line 400 in accordance with the fourth embodiment, FIG. 8B is a plan view of the conductor layers 10 and 11 employed in the fourth embodiment, and FIG. 8C is a plan view of the conductor layer 14 employed in the fourth embodiment.

As illustrated in FIG. 8A, the signal transmission line 400 of the fourth embodiment includes the dielectric substrate 2, the first transmission line 4, the second transmission line 6, the via interconnection 8, and the conductor layers 10, 11 and 14. The dielectric substrate 2 has a four-layer structure composed of dielectric layers 2a, 2b, 2c and 2d. The first and second transmission lines 4 and 6 form microstrip lines.

The inside of the dielectric substrate 2 has the conductor layer 10 (first conductor layer), the conductor layer 14 (the second conductor layer), and the conductor layer 11 (third conductor layer) in this order from the top side. That is, the conductor layer 14 is provided between the conductor layer 10 and the upper surface of the dielectric layer 2d. The conductor layer 11 is provided between the conductor layer 14 and the lower surface of the dielectric layer 2d. That is, the conductor layer 14 is sandwiched between the conductor layer 10 and the conductor layer 11.

As illustrated in FIG. 8B, the conductor layer 10 and the conductor layer 11 of the fourth embodiment have the same structure as that of the conductor layer 10 of the first embodiment. That is, an opening 13 is formed in the conductor layer 11 so that the distance between the conductor layer 11 and the land pattern 9 in the direction in which the second signal conductor 22 extends is smaller than the distance between the conductor layer 11 and the land pattern 9 in the direction orthogonal to the direction in which the second signal conductor 22 extends.

As illustrated in FIG. 8C, a circular opening 16 (second opening) is formed in the conductor layer 14. That is, the opening 16 is formed so that the distance between the conductor layer 14 and the land pattern 9 in the direction in which the first signal conductor 18 extends is equal to the distance between the conductor layer 10 and the land pattern 9 in the direction orthogonal to the direction in which the first signal conductor 18 extends. The opening 16 is formed so that the distance between the conductor layer 14 and the land pattern 9 in the direction in which the second signal conductor 22 extends is equal to the distance between the conductor layer 14 and the land pattern 9 in the direction orthogonal to the direction in which the second signal conductor 22 extends. The via interconnection 8 and the conductor layer 14 are configured so that the characteristic impedance of the via interconnection 8 is close to the characteristic impedances of the first and second transmission lines 4 and 6 (for example, 50Ω).

The openings 12 and 13 are respectively formed in the conductor layers 10 and 11 so that the distances between the conductor layers 10 and 11 and the land pattern 9 are relatively small in the direction in which the transmission lines extend. With this structure, the characteristic impedances of the first and second transmission lines 4 and 6 may be maintained at a desired value (for example, 50Ω) up to the proximity of the via interconnection 8. and the impedance discontinuity may be thus reduced.

The opening 16 of the conductor layer 14 does not substantially provide the first and second transmission lines 4 and 6 with the ground potential. Thus, the continuity of the first and second transmission lines 4 and 6 is less affected. Thus, the opening 16 may be formed in a circular shape. That is, the via interconnection 8 is configured to have a desired characteristic impedance by a portion coupled with the ground potential of the conductor layers 10 and 11 in the elliptical openings 12 and 13 and another portion coupled with the ground potential of the conductor layer 14 in the circular opening 16.

As described above, according to the present embodiment, it is possible to reduce the impedance discontinuity of the connection of the first and second transmission lines 4 and 6 and the via interconnection 8. It is easy to make the impedance of the via interconnection 8 close to the impedance of the first transmission line 4 and that of the second transmission line 6. Thus, it is possible to reduce the loss of signal on the signal transmission line. The number of conductor layers is not limited to three employed in the present embodiment, but may be two, four or more.

### Fifth Embodiment

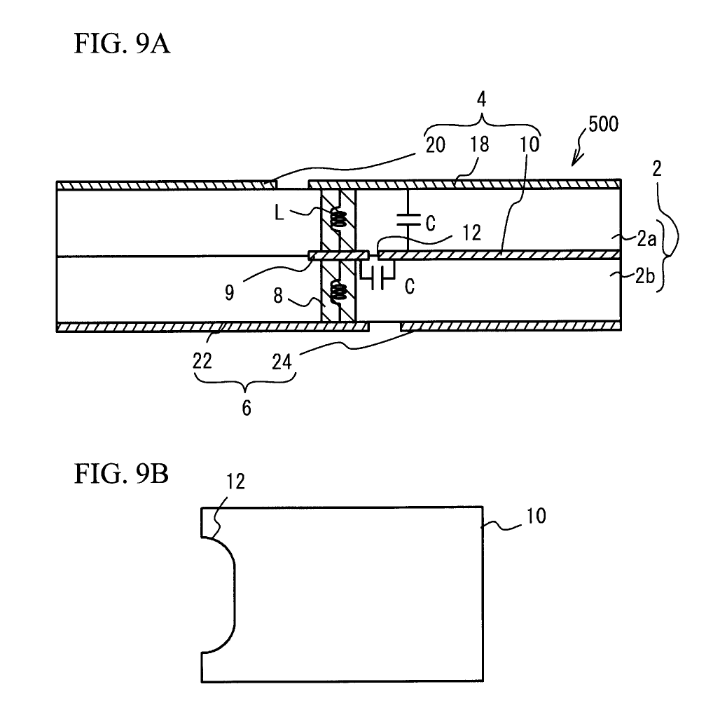

A fifth embodiment is an example in which an opening in the conductor layer is open. FIG. 9A is a cross-sectional view of a signal transmission line 500 in accordance with the fifth embodiment, and FIG. 9B is a plan view of the conductor layer 10 employed in the fifth embodiment.

As illustrated in FIGS. 9A and 9B, the conductor layer 10 extends in the direction in which the first signal conductor 18 extends. The opening 12 is formed in the conductor layer 10. A portion of the opening 12 beyond the via interconnection 8 in the direction in which the first signal conductor 18 extends is open.

As illustrated in FIG. 9B, the opening 12 is formed so that the distance between the conductor layer 10 and the land pattern 9 in the direction in which the first signal conductor 18 extends is smaller than the distance between the conductor layer 10 and the land pattern 9 in the direction orthogonal to the direction in which the first signal conductor 18 extends. The first transmission line 4 is a grounded coplanar line, and the second transmission line 6 is a coplanar line.

According to the fifth embodiment, although the side of the opening 12 in which the second signal conductor 22 extends is open, the impedance discontinuity of the connection between the first transmission line 4 and the via interconnection 8 may be reduced. It is easy to make the impedance of the via interconnection 8 close to the impedance of the first transmission line 4 and that of the second transmission line 6. Thus, it is possible to reduce the loss of signal on the signal transmission line.

### Sixth Embodiment

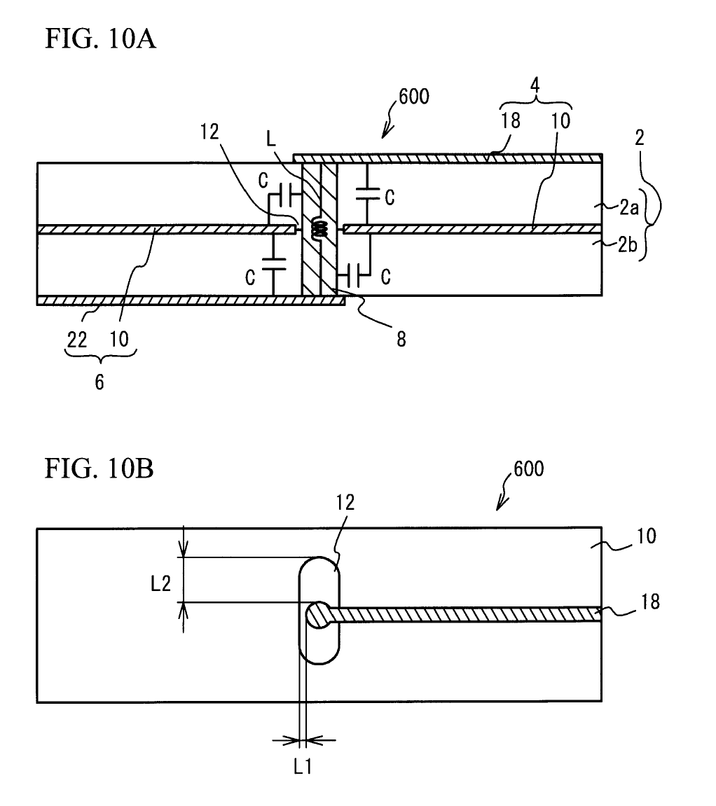

A sixth embodiment is an example in which the via interconnection 8 exists in an opening in a conductor layer, but the land pattern 9 does not exist in this opening. FIG. 10A is a cross-sectional view of a signal transmission line 600 in accordance with the sixth embodiment, and FIG. 10B is a plan view of the signal transmission line 600. In FIG. 10B, the components are seen through the dielectric layer 2a. The first transmission line 4 is the same as that illustrated in FIG. 5C.

As illustrated in FIGS. 10A and 10B, the signal transmission line 600 of the sixth embodiment is equipped with the dielectric substrate 2, the first transmission line 4, the second transmission line 6, the via interconnection 8 and the conductor layer 10. That is, the signal transmission line 600 may be structured as if the land pattern 9 is removed from the signal transmission line 100 of the first embodiment. Like the first embodiment, the first and second signal transmission lines 4 and 6 are formed by microstrip lines.

As illustrated in FIG. 10B, the opening 12 is formed so that the distance L1 between the conductor layer 10 and the via interconnection 8 in the direction in which the first signal conductor 18 extends is smaller than the distance 11 between the conductor layer 10 and the via interconnection 8 in the direction orthogonal to the direction in which the first transmission line 4. The distance L1 is smaller than the distance between the conductor layer 10 and the via interconnection 8 in the direction orthogonal to the direction in which the first transmission line 4 extends. The conductor layer 10 surrounds the opening 12. The via interconnection 8 and the conductor layer 10 are configured so that the characteristic impedance of the via interconnection 8 is close to the characteristic impedances (for example, 50Ω) of the first and second transmission lines 4 and 6.

According to the sixth embodiment, since the distance L1 is relatively small, the characteristic impedance of the first signal conductor 18 may be maintained at a desired value (for example, 50Ω) up to the proximity of the via interconnection 8. Similarly, the characteristic impedance of the second signal conductor 22 may be maintained at a desired value up to the proximity of the via interconnection 8. It is easy to make the impedance of the via interconnection 8 close to the impedance of the first transmission line 4 and that of the second transmission line 6. Thus, it is possible to obtain the desired impedance and reduce the loss of signal on the signal transmission line.

In the above-described embodiments, the first and second transmission lines 4 and 6 are preferably microstrip lines, coplanar lines, or grounded coplanar lines in order to obtain reliable transmission characteristics. However, another type of transmission line may be employed, and the present invention includes transmission lines composed of a signal conductor and a ground conductor coupled with the signal conductor.

The present invention is not limited to the above-described embodiments and variations but may include other embodiments and variations without departing from the scope of the present invention.

What is claimed is:

1. A signal transmission line comprising:
a dielectric substrate having a first surface and a second surface opposite to the first surface;
a first conductor layer provided between the first surface and the second surface and set at a ground potential;
a first transmission line having a signal conductor that is provided on the first surface and has a capacitive coupling with the first conductor layer;
a second transmission line provided on the second surface; and
a connecting conductor that passes through the dielectric substrate and connects the signal conductor of the first transmission line and the second transmission line,
the first conductor layer having a first opening in which the connecting conductor is located,
a distance between the first conductor layer and the connecting conductor in a first direction in which the signal conductor of the first transmission line extends being smaller than a distance between the first conductor layer and the connecting conductor in a second direction orthogonal to the first direction.

2. The signal transmission line according to claim 1, wherein the first transmission line is one of a microstrip line having a ground potential defined by the ground potential of the first conductor layer, and a grounded coplanar line having ground potentials defined by a potential of a ground conductor provided on the first surface and the ground potential of the first conductor layer.

3. The signal transmission line according to claim 1, wherein the second transmission line is one of a coplanar line, a microstrip line having a ground potential defined by the ground potential of the first conductor layer, and a ground coplanar line having ground potentials defined by a potential of aground conductor provided on the second surface and the ground potential of the first conductor layer.

4. The signal transmission line according to claim 1, further comprising a second conductor layer provided between the first conductor layer and the second surface, wherein the second conductor layer has a second opening in which the connecting conductor is located,
a distance between the second conductor layer and the connecting conductor in the first direction in which the signal conductor of the first transmission line extends being equal to a distance between the second conductor layer and the connecting conductor in the second direction orthogonal to the first direction.

5. The signal transmission line according to claim 4, further comprising a third conductor provided between the second conductor and the second surface, wherein the third conductor layer has a third opening in which the connecting conductor is located,
a distance between the third conductor layer and the connecting conductor in the first direction in which the signal conductor of the first signal transmission line extends being smaller than a distance between the third conductor layer and the connecting conductor in the second direction orthogonal to the first direction.

6. The signal transmission line according to claim 1, wherein the first conductor layer surrounds the first opening.

7. The signal transmission line according to claim 1, wherein the first opening has a portion that is open in a direction opposite to the first direction in which the signal conductor of the first transmission line extends.

8. The signal transmission line according to claim 1, wherein the dielectric substrate made from ceramic.

9. A signal transmission line comprising:
a dielectric substrate having a first surface and a second surface opposite to the first surface;
a first conductor layer provided between the first surface and the second surface of the dielectric substrate;
a first transmission line provided on the first surface of the dielectric substrate and extended in a first direction, a first opening being provided in the first conductor layer;
a second transmission line provided on the second surface of the dielectric substrate; and
a connecting conductor extended through the dielectric substrate via the first opening, and connected between the first transmission line and the second transmission line,
a distance between the connecting conductor and an edge of the first opening in the first direction being smaller than a distance between the connecting conductor and another edge of the first opening in a second direction orthogonal to the first direction.

10. The signal transmission line according to claim 9, wherein the first transmission line is one of a microstrip line coupled with a ground potential of the first conductor layer, and a grounded coplanar line coupled with a ground potential of the first conductor layer.

11. The signal transmission line according to claim 9, wherein the second transmission line is one of a coplanar line, a microstrip line coupled with a ground potential of the first conductor layer, and a grounded coplanar line coupled with a ground potential of the first conductor layer.

12. The signal transmission line according to claim 9, further comprising;
a second conductor layer provided between the first conductor layer and the second surface of the dielectric substrate; and
a second opening provided in the second conductor layer,
the connecting conductor extended through the dielectric substrate via the first opening and the second opening, and connected between the first transmission line and the second transmission line,
a distance between the connecting conductor and an edge of the second opening in the first direction being equal to a distance between then connecting conductor and another edge of the second opening in a second direction orthogonal to the first direction.

13. The signal transmission line according to claim 12, further comprising;
a third conductor provided between the second conductor and the second surface of the dielectric substrate; and
a third opening provided in the third conductor layer,
the connecting conductor extended through the dielectric substrate via the first opening, the second opening and the third opening, and connected between the first transmission line and the second transmission line,
a distance between the connecting conductor and an edge of the third opening in the first direction being smaller than a distance between then connecting conductor and another edge of the third opening in the second direction orthogonal to the first direction.

14. The signal transmission line according to claim 9, wherein the first opening is surrounded by the first conductor layer.

15. The signal transmission line according to claim 9, wherein the first opening has an edge that is absence of the first conductor layer.

16. The signal transmission line according to claim 9, wherein the dielectric substrate is made from ceramic.
